(19) United States
(12) Patent Application Publication
(10) Pub. No.: US 2006/0159774 A1
(43) Pub. Date: Jul. 20, 2006

(54) Red tide organism killer

(76) Inventor: Robert B. Rigby, Nokomis, FL (US)

Correspondence Address: EDWARD P. DUTKIEWICZ, ESQ.;EDWARD P. DUTKIEWICZ, P.A., 640 DOUGLAS AVENUE, DUNEDIN, FL, 34698-7001, US

(21) Appl. No.: 11/035,597

(22) Filed: Jan. 14, 2005

(51) Int. Cl. A01N 59/08

(52) U.S. Cl. 424/661

(57) ABSTRACT

The composition is a red tide organism killer comprising between about 5 percent and about 15 percent sodium hypochlorite and between about 95 percent and about 85 percent inert ingredients in solution and a mixture of the composition and contaminated water. The composition is admixed into the contaminated water at a rate of between about 1 part per million and about 5 parts per million.

### BACKGROUND OF THE INVENTION

1. Field of the Invention

The present invention relates to a red tide organism killer and more particularly pertains to killing and managing a red tide and other dinoflagelents.

2. Description of the Prior Art

The use of algicides of known designs and configurations is known in the prior art. More specifically, algicides of known designs and configurations previously devised and utilized for the purpose of killing algae are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 4,840,658 issued Jun. 20, 1989 to Kakisawa relates to an algicidal composition. U.S. Pat. No. 5,518,990 issued May 21, 1996 to Ushio relates to a method for preventing emergence of algae and antialgal compositions. Lastly, U.S. Pat. No. 6,669,969 issued Dec. 30, 2003 to Noren relates to pesticidal use of a parasetic flagellate for eliminating or suppressing harmful algae blooms.

While these devices fulfill their respective, particular objectives and requirements, the aforementioned patents do not describe a red tide organism killer that allows for killing and managing red tide and other dinoflagelents.

In this respect, the red tide organism killer according to the present invention substantially departs from the conventional concepts and designs of the prior art, and in doing so provides an apparatus primarily developed for the purpose of killing and managing red tide and other dinoflagelents.

Therefore, it can be appreciated that there exists a continuing need for a new and improved red tide organism killer which can be used for killing and managing a red tide and other dinoflagelents. In this regard, the present invention substantially fulfills this need.

### SUMMARY OF THE INVENTION

In view of the foregoing disadvantages inherent in the known types of algicides of known designs and configurations now present in the prior art, the present invention provides an improved red tide organism killer. As such, the general purpose of the present invention, which will be described subsequently in greater detail, is to provide a new and improved red tide organism killer and method which has all the advantages of the prior art and none of the disadvantages.

To attain this, the present invention essentially comprises a red tide organism killer is comprised of a plurality of components. Such components in their broadest context include sodium hypochlorite and inert ingredients. Such components are individually configured and correlated with respect to each other so as to attain the desired objective of constituting a red tide organism killer for killing and managing red tide and other dinoflagelents including gymnodinium breve, karenia brevis, ptychodiscus, pfiesteria piscicida and the like. The components comprise, in combination, a composition of between about 5 percent and about 15 percent, preferably 10 percent, sodium hypochlorite and between about 95 percent and about 85 percent inert ingredients in solution. The inert ingredients are selected from the class of inert ingredients including unionized water, sodium carbonate and sodium chloride.

Next provided is a mixture of the composition and contaminated water containing dinoflagelents including gymnodinium breve, karenia brevis, ptychodiscus, pfiesteria piscicida and the like. The composition is admixed into the contaminated water at a rate of between about 1 part per million and about 5 parts per million depending on the rate of the organism colony count in the contaminated water.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved red tide organism killer which has all of the advantages of the prior art algicides of known designs and configurations and none of the disadvantages.

It is another object of the present invention to provide a new and improved red tide organism killer which may be easily and efficiently manufactured and marketed.

An even further object of the present invention is to provide a new and improved red tide organism killer which is susceptible of a low cost of manufacture with regard to both materials and labor, and which accordingly is then susceptible of low prices of sale.

Even still another object of the present invention is to provide a red tide organism killer for killing and managing a red tide organism.

Lastly, it is an object of the present invention to provide a new and improved composition, a red tide organism killer, comprising between about 5 percent and about 15 percent sodium hypochlorite and between about 95 percent and about 85 percent inert ingredients in solution and a mixture of the composition and contaminated water. The composition is admixed into the contaminated water at a rate of between about 1 part per million and about 5 parts per million.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the within descriptive matter wherein preferred embodiments of the invention are described.

The invention will be better understood and objects other than those set forth above will become apparent when consideration is given to the following detailed description thereof.

### DESCRIPTION OF THE PREFERRED EMBODIMENT

The present invention, the red tide organism killer is comprised of a plurality of components. Such components in their broadest context include sodium hypochlorite and inert ingredients. Such components are individually configured and correlated with respect to each other so as to attain the desired objective of constituting a red tide organism killer for killing and managing red tide and other dinoflagelents including gymnodinium breve, karenia brevis, ptychodiscus, pfiesteria piscicida and the like. The components comprise, in combination, a composition of between about 5 percent and about 15 percent, preferably 10 percent, sodium hypochlorite and between about 95 percent and about 85 percent inert ingredients in solution. The inert ingredients are selected from the class of inert ingredients including unionized water, sodium carbonate and sodium chloride.

Next provided is a mixture of the composition and contaminated water containing dinoflagelents including gymnodinium breve, karenia brevis, ptychodiscus, pfiesteria piscicida and the like. The composition is admixed into the contaminated water at a rate of between about 1 part per million and about 5 parts per million depending on the rate of the organism colony count in the contaminated water.

A first example includes a composition at about 10 percent sodium hypochlorite and about 90 percent inert ingredients and the composition is admixed into the contaminated water at a rate of about 3 part per million.

A second example includes a composition at about 15 percent sodium hypochlorite and about 85 percent inert ingredients and the composition is admixed into the contaminated water at a rate of about 1 part per million.

A third example includes a composition at about 5 percent sodium hypochlorite and about 95 percent inert ingredients and the composition is admixed into the contaminated water at a rate of about 5 part per million.

These first three examples are for relatively average concentrations of contaminants in the water. For greater or lesser concentrations of contaminants, there are fourth and fifth examples.

The fourth example includes a composition at about 15 percent sodium hypochlorite and about 85 percent inert ingredients and the composition is admixed into the contaminated water at a rate of about 5 part per million.

The fifth example includes a composition at about 5 percent sodium hypochlorite and about 95 percent inert ingredients and the composition is admixed into the contaminated water at a rate of about 1 part per million.

A preferred system for dispensing the red tide killer of the present invention is set forth in co-pending U.S. patent application Ser. No. RD50/03 filed by me concurrently here with.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in ratios and proportions, function and manner of operation and use, are deemed readily apparent and obvious to one skilled in the art, and all equivalent relationships described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact combination and operation shown and described, and accordingly, all suitable modifications and equivalents may be resorted to, falling within the scope of the invention.

What is claimed as being new and desired to be protected by LETTERS PATENT of the United States is as follows:

1. A red tide organism killer comprising:
a composition of between about 5 percent and about 15 percent sodium hypochlorite and between about 95 percent and about 85 percent inert ingredients in solution; and
a mixture of the composition and water contaminated with dinoflagellates having a sodium hypochlorite concentration of between about 1 and 5 parts per million.

2. The red tide organism killer as set forth in claim 1 wherein the composition is at about 10 percent sodium hypochlorite and about 90 percent inert ingredients and the composition is admixed into the contaminated water at a rate of about 3 parts per million.

3. The red tide organism killer as set forth in claim 1 wherein the composition is at about 15 percent sodium hypochlorite and about 85 percent inert ingredients and the composition is admixed into the contaminated water at a rate of about 1 part per million.

4. The red tide organism killer as set forth in claim 1 wherein the composition is at about 5 percent sodium hypochlorite and about 95 percent inert ingredients and the composition is admixed into the contaminated water at a rate of about 5 parts per million.

5. The red tide organism killer as set forth in claim 1 wherein the composition is at about 15 percent sodium hypochlorite and about 85 percent inert ingredients and the composition is admixed into the contaminated water at a rate of about 5 parts per million.

6. The red tide organism killer as set forth in claim 1 wherein the composition is at about 5 percent sodium hypochlorite and about 95 percent inert ingredients and the composition is admixed into the contaminated water at a rate of about 1 part per million.

7. The red tide organism killer as set forth in claim 1 wherein the inert ingredients are selected from the class of inert ingredients including unionized water, sodium carbonate and sodium chloride.

8. A red tide organism killer for killing and managing red tide and other dinoflagellates including gymnodinium breve, karenia brevis, ptychodiscus, pfiesteria piscicida and the like, comprising, in combination:
a composition of between about 5 percent and about 15 percent, sodium hypochlorite and between about 95 percent and about 85 percent inert ingredients in solution, the inert ingredients being selected from the class of inert ingredients including unionized water, sodium carbonate and sodium chloride; and
a mixture of the composition and contaminated water containing dinoflagellates including gymnodinium breve, karenia brevis, ptychodiscus, pfiesteria piscicida and the like, the composition having a sodium hypochlorite concentration of between about 1 part per million and about 5 parts per million.
